(19) United States
(12) Patent Application Publication
(10) Pub. No.: US 2026/0340660 A1
(43) Pub. Date: Oct. 29, 2026

(54) PRODUCT AUTHENTICITY CHECKING

(71) Applicant: International Business Machines Corporation, Armonk, NY (US)

(72) Inventors: Priti Ashvin Shah, Basking Ridge, NJ (US); Sagarika Mukesh, Albany, NY (US); Kevin Wayne Brew, Niskayuna, NY (US); Jaime Morillo, Cedar Park, TX (US)

(21) Appl. No.: 19/187,087

(22) Filed: Apr. 23, 2025

(51) Int. Cl. G06Q 30/018; G06T 7/00; G06V 10/40

(52) U.S. Cl. CPC G06Q 30/0185; G06T 7/001; G06V 10/40; G06T 2207/20084

(57) ABSTRACT

A computer-implemented method for product authenticity checking is provided and includes training an artificial intelligence (AI) model for product authenticity checking using characteristic data and material data of baseline products known to be authentic, generating imagery and material information of a field product of unknown authenticity using image generating components and scanning components, respectively, of a portable computing device and deriving characteristic data and material data of the field product from the imagery and the material information, respectively. The computer-implemented method further includes determining, using the AI model, a likelihood-of-authenticity score of the field product based on results of first comparisons between the characteristic data of the field product and the characteristic data of the baseline products and second comparisons between the material data of the field product and the material data of the baseline products.

### BACKGROUND

The present invention generally relates to artificial intelligence in computing systems. More specifically, the present invention relates to systems and methods for using artificial intelligence provide for product authenticity checking.

The exchange or sale of physical assets, such as products like consumer goods, is often unsecure. When a customer/consumer purchases a physical object such as clothing, consumer devices, equipment, etc., they tend to take the seller's word that the seller has authority to sell the asset. Meanwhile, manufacturers are always looking for new channels to sell their products. As a result, real-world marketplaces, stores and second-hand markets as well as online marketplaces, second-hand purchase websites and mobile applications, and the like, have all become attractive channels for selling and/or exchanging physical assets.

### SUMMARY

According to an aspect of the disclosure, a computer-implemented method for product authenticity checking is provided and includes training an artificial intelligence (AI) model for product authenticity checking using characteristic data and material data of baseline products known to be authentic, generating imagery and material information of a field product of unknown authenticity using image generating components and scanning components, respectively, of a portable computing device and deriving characteristic data and material data of the field product from the imagery and the material information, respectively. The computer-implemented method further includes determining, using the AI model, a likelihood-of-authenticity score of the field product based on results of first comparisons between the characteristic data of the field product and the characteristic data of the baseline products and second comparisons between the material data of the field product and the material data of the baseline products and issuing an alert as to the likelihood-of-authenticity score of the field product in relation to a first threshold. This allows for relatively easy and simple product authenticity checking of products that a consumer (end consumer or online marketplace) encounters.

According to an aspect of the disclosure, a computer program product for product authenticity checking is provided and includes one or more computer readable storage media having computer readable program code collectively stored on the one or more computer readable storage media. The computer readable program code is executed by a processor of a computer system to cause the computer system to perform a method. The method includes training an artificial intelligence (AI) model for product authenticity checking using characteristic data and material data of baseline products known to be authentic, generating imagery and material information of a field product of unknown authenticity using image generating components and scanning components, respectively, of a portable computing device and deriving characteristic data and material data of the field product from the imagery and the material information, respectively. The method further includes determining, using the AI model, a likelihood-of-authenticity score of the field product based on results of first comparisons between the characteristic data of the field product and the characteristic data of the baseline products and second comparisons between the material data of the field product and the material data of the baseline products and issuing an alert as to the likelihood-of-authenticity score of the field product in relation to a first threshold. This allows for relatively easy and simple product authenticity checking of products that a consumer (end consumer or online marketplace) encounters.

According to an aspect of the disclosure, a computing system is provided and includes a processor, a memory coupled to the processor and one or more computer readable storage media coupled to the processor. The one or more computer readable storage media collectively contain instructions that are executed by the processor via the memory to implement a method for product authenticity checking. The method for product authenticity checking includes training an artificial intelligence (AI) model for product authenticity checking using characteristic data and material data of baseline products known to be authentic, generating imagery and material information of a field product of unknown authenticity using image generating components and scanning components, respectively, of a portable computing device and deriving characteristic data and material data of the field product from the imagery and the material information, respectively. The method for product authenticity checking further includes determining, using the AI model, a likelihood-of-authenticity score of the field product based on results of first comparisons between the characteristic data of the field product and the characteristic data of the baseline products and second comparisons between the material data of the field product and the material data of the baseline products and issuing an alert as to the likelihood-of-authenticity score of the field product in relation to a first threshold. This allows for relatively easy and simple product authenticity checking of products that a consumer (end consumer or online marketplace) encounters.

In accordance with one or more additional and/or alternative embodiments of the present invention, the characteristic data and the material data of the baseline products are stored in a multi-modal database of one or more products of one or more brands, the training includes developing brand fingerprints for each of the one or more brands and the likelihood-of-authenticity score of the field product is a function of the results of the first comparisons and the second comparisons indicating a degree to which the field product matches a brand fingerprint with a higher likelihood-of-authenticity score indicating that the field product substantially matches a brand fingerprint and a lower likelihood-of-authenticity score indicating a lack of a match.

In accordance with one or more additional and/or alternative embodiments of the present invention, the method for product authenticity checking further includes at least one of updating the characteristic data and the material data of the baseline products known to be authentic using the characteristic data and the material data of the field product in an event the likelihood-of-authenticity score of the field product is above a second threshold and updating the characteristic data and the material data of the baseline products known to be authentic in an event of a change in a country-of-origin of a baseline product where the updating allows for dynamic changes to the system as products change over time.

In accordance with one or more additional and/or alternative embodiments of the present invention, the image generating components include a camera of the portable computing device, the camera being configured to generate 2D and 3D images of the field product and a tag thereof, the scanning components include at least one of sensors embedded in the portable computing device and sensors attached to the portable computing device, the at least one of the sensors embedded in the portable computing device and the sensors attached to the portable computing device being configured to generate at least a spectroscopic signature of the field product and the portable computing device includes at least one of a smartphone, a tablet, a hand-held computing device and a robotic computing device so that users can execute product authenticity checking using their phone, for example.

In accordance with one or more additional and/or alternative embodiments of the present invention, the method for product authenticity checking further includes setting the first threshold based on a tolerance level of a mission critical product.

In accordance with one or more additional and/or alternative embodiments of the present invention, the AI model is stored on a computing resource, which is owned and operated by a trusted third part and which is accessible by an authorized user of the portable computing device via a network, where the computing resource can be owned or operated by a trusted third party

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a schematic diagram of a computing environment for product authenticity checking in accordance with one or more embodiments of the present invention;

FIG. 2 is a block diagram of components of a machine learning training and inference system for product authenticity checking according to one or more embodiments of the present invention;

FIG. 3 is a flow diagram illustrating a computer-implemented method for product authenticity checking in accordance with one or more embodiments of the present invention;

FIG. 4 is a schematic diagram illustrating a system for executing the computer-implemented method of FIG. 3 in accordance with one or more embodiments of the present invention; and

FIG. 5 is a graphical flow diagram illustrating an operation of the computer-implemented method of FIG. 3 in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the described embodiments, the various elements illustrated in the figures are provided with two- or three-digit reference numbers. With minor exceptions, the leftmost digit(s) of each reference number correspond to the figure in which its element is first illustrated.

### DETAILED DESCRIPTION

According to an aspect of the disclosure, a computer-implemented method for product authenticity checking is provided and includes training an artificial intelligence (AI) model for product authenticity checking using characteristic data and material data of baseline products known to be authentic, generating imagery and material information of a field product of unknown authenticity using image generating components and scanning components, respectively, of a portable computing device and deriving characteristic data and material data of the field product from the imagery and the material information, respectively. The computer-implemented method further includes determining, using the AI model, a likelihood-of-authenticity score of the field product based on results of first comparisons between the characteristic data of the field product and the characteristic data of the baseline products and second comparisons between the material data of the field product and the material data of the baseline products and issuing an alert as to the likelihood-of-authenticity score of the field product in relation to a first threshold. This allows for relatively easy and simple product authenticity checking of products that a consumer (end consumer or online marketplace) encounters.

In accordance with one or more additional and/or alternative embodiments of the present invention, the characteristic data and the material data of the baseline products are stored in a multi-modal database of one or more products of one or more brands, the training includes developing brand fingerprints for each of the one or more brands and the likelihood-of-authenticity score of the field product is a function of the results of the first comparisons and the second comparisons indicating a degree to which the field product matches a brand fingerprint with a higher likelihood-of-authenticity score indicating that the field product substantially matches a brand fingerprint and a lower likelihood-of-authenticity score indicating a lack of a match.

In accordance with one or more additional and/or alternative embodiments of the present invention, the computer-implemented method further includes at least one of updating the characteristic data and the material data of the baseline products known to be authentic using the characteristic data and the material data of the field product in an event the likelihood-of-authenticity score of the field product is above a second threshold and updating the characteristic data and the material data of the baseline products known to be authentic in an event of a change in a country-of-origin of a baseline product where the updating allows for dynamic changes to the system as products change over time.

In accordance with one or more additional and/or alternative embodiments of the present invention, the image generating components include a camera of the portable computing device, the camera being configured to generate 2D and 3D images of the field product and a tag thereof, the scanning components include at least one of sensors embedded in the portable computing device and sensors attached to the portable computing device, the at least one of the sensors embedded in the portable computing device and the sensors attached to the portable computing device being configured to generate at least a spectroscopic signature of the field product and the portable computing device includes at least one of a smartphone, a tablet, a hand-held computing device and a robotic computing device so that users can execute product authenticity checking using their phone, for example.

In accordance with one or more additional and/or alternative embodiments of the present invention, the scanning components include at least one or more of ultraviolet-visible (UV-VIS) scanners, Fourier transform infrared spectroscopy (FTIR) scanners and Raman scanners to allow for a material analysis of a field product.

In accordance with one or more additional and/or alternative embodiments of the present invention, the computer-implemented method further includes setting the first threshold based on a tolerance level of a mission critical product such that product authenticity checking can take place for a mission critical product with little to no tolerance for counterfeit products.

In accordance with one or more additional and/or alternative embodiments of the present invention, in an event the likelihood-of-authenticity score of the field product is below the first threshold, the computer-implemented method further includes evaluating the characteristic data and the material data of the field product relative to a brand fingerprint, determining, by the AI model, a vicarious confidence in an authenticity of the field product based on results of the evaluating indicating a likely match between the characteristic data and the material data of the field product relative to the brand fingerprint and flagging, by the AI model, the field product as counterfeit based on the results of the evaluating indicating an unlikely match between the characteristic data and the material data of the field product relative to the brand fingerprint especially in cases where there is limited data about a given field product available.

In accordance with one or more additional and/or alternative embodiments of the present invention, the AI model is stored on a computing resource, which is owned and operated by a trusted third part and which is accessible by an authorized user of the portable computing device via a network, where the computing resource can be owned or operated by a trusted third party.

According to an aspect of the disclosure, a computer program product for product authenticity checking is provided and includes one or more computer readable storage media having computer readable program code collectively stored on the one or more computer readable storage media. The computer readable program code is executed by a processor of a computer system to cause the computer system to perform a method. The method includes training an artificial intelligence (AI) model for product authenticity checking using characteristic data and material data of baseline products known to be authentic, generating imagery and material information of a field product of unknown authenticity using image generating components and scanning components, respectively, of a portable computing device and deriving characteristic data and material data of the field product from the imagery and the material information, respectively. The method further includes determining, using the AI model, a likelihood-of-authenticity score of the field product based on results of first comparisons between the characteristic data of the field product and the characteristic data of the baseline products and second comparisons between the material data of the field product and the material data of the baseline products and issuing an alert as to the likelihood-of-authenticity score of the field product in relation to a first threshold. This allows for relatively easy and simple product authenticity checking of products that a consumer (end consumer or online marketplace) encounters.

In accordance with one or more additional and/or alternative embodiments of the present invention, the characteristic data and the material data of the baseline products are stored in a multi-modal database of one or more products of one or more brands, the training includes developing brand fingerprints for each of the one or more brands and the likelihood-of-authenticity score of the field product is a function of the results of the first comparisons and the second comparisons indicating a degree to which the field product matches a brand fingerprint with a higher likelihood-of-authenticity score indicating that the field product substantially matches a brand fingerprint and a lower likelihood-of-authenticity score indicating a lack of a match.

In accordance with one or more additional and/or alternative embodiments of the present invention, the method further includes at least one of updating the characteristic data and the material data of the baseline products known to be authentic using the characteristic data and the material data of the field product in an event the likelihood-of-authenticity score of the field product is above a second threshold and updating the characteristic data and the material data of the baseline products known to be authentic in an event of a change in a country-of-origin of a baseline product where the updating allows for dynamic changes to the system as products change over time.

In accordance with one or more additional and/or alternative embodiments of the present invention, the image generating components include a camera of the portable computing device, the camera being configured to generate 2D and 3D images of the field product and a tag thereof, the scanning components include at least one of sensors embedded in the portable computing device and sensors attached to the portable computing device, the at least one of the sensors embedded in the portable computing device and the sensors attached to the portable computing device being configured to generate at least a spectroscopic signature of the field product and the portable computing device includes at least one of a smartphone, a tablet, a hand-held computing device and a robotic computing device so that users can execute product authenticity checking using their phone, for example.

In accordance with one or more additional and/or alternative embodiments of the present invention, the method further includes setting the first threshold based on a tolerance level of a mission critical product.

In accordance with one or more additional and/or alternative embodiments of the present invention, the AI model is stored on a computing resource, which is owned and operated by a trusted third part and which is accessible by an authorized user of the portable computing device via a network, where the computing resource can be owned or operated by a trusted third party.

According to an aspect of the disclosure, a computing system is provided and includes a processor, a memory coupled to the processor and one or more computer readable storage media coupled to the processor. The one or more computer readable storage media collectively contain instructions that are executed by the processor via the memory to implement a method for product authenticity checking. The method for product authenticity checking includes training an artificial intelligence (AI) model for product authenticity checking using characteristic data and material data of baseline products known to be authentic, generating imagery and material information of a field product of unknown authenticity using image generating components and scanning components, respectively, of a portable computing device and deriving characteristic data and material data of the field product from the imagery and the material information, respectively. The method for product authenticity checking further includes determining, using the AI model, a likelihood-of-authenticity score of the field product based on results of first comparisons between the characteristic data of the field product and the characteristic data of the baseline products and second comparisons between the material data of the field product and the material data of the baseline products and issuing an alert as to the likelihood-of-authenticity score of the field product in relation to a first threshold. This allows for relatively easy and simple product authenticity checking of products that a consumer (end consumer or online marketplace) encounters.

In accordance with one or more additional and/or alternative embodiments of the present invention, the characteristic data and the material data of the baseline products are stored in a multi-modal database of one or more products of one or more brands, the training includes developing brand fingerprints for each of the one or more brands and the likelihood-of-authenticity score of the field product is a function of the results of the first comparisons and the second comparisons indicating a degree to which the field product matches a brand fingerprint with a higher likelihood-of-authenticity score indicating that the field product substantially matches a brand fingerprint and a lower likelihood-of-authenticity score indicating a lack of a match.

In accordance with one or more additional and/or alternative embodiments of the present invention, the method for product authenticity checking further includes at least one of updating the characteristic data and the material data of the baseline products known to be authentic using the characteristic data and the material data of the field product in an event the likelihood-of-authenticity score of the field product is above a second threshold and updating the characteristic data and the material data of the baseline products known to be authentic in an event of a change in a country-of-origin of a baseline product where the updating allows for dynamic changes to the system as products change over time.

In accordance with one or more additional and/or alternative embodiments of the present invention, the image generating components include a camera of the portable computing device, the camera being configured to generate 2D and 3D images of the field product and a tag thereof, the scanning components include at least one of sensors embedded in the portable computing device and sensors attached to the portable computing device, the at least one of the sensors embedded in the portable computing device and the sensors attached to the portable computing device being configured to generate at least a spectroscopic signature of the field product and the portable computing device includes at least one of a smartphone, a tablet, a hand-held computing device and a robotic computing device so that users can execute product authenticity checking using their phone, for example.

In accordance with one or more additional and/or alternative embodiments of the present invention, the method for product authenticity checking further includes setting the first threshold based on a tolerance level of a mission critical product.

In accordance with one or more additional and/or alternative embodiments of the present invention, the AI model is stored on a computing resource, which is owned and operated by a trusted third part and which is accessible by an authorized user of the portable computing device via a network, where the computing resource can be owned or operated by a trusted third party.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

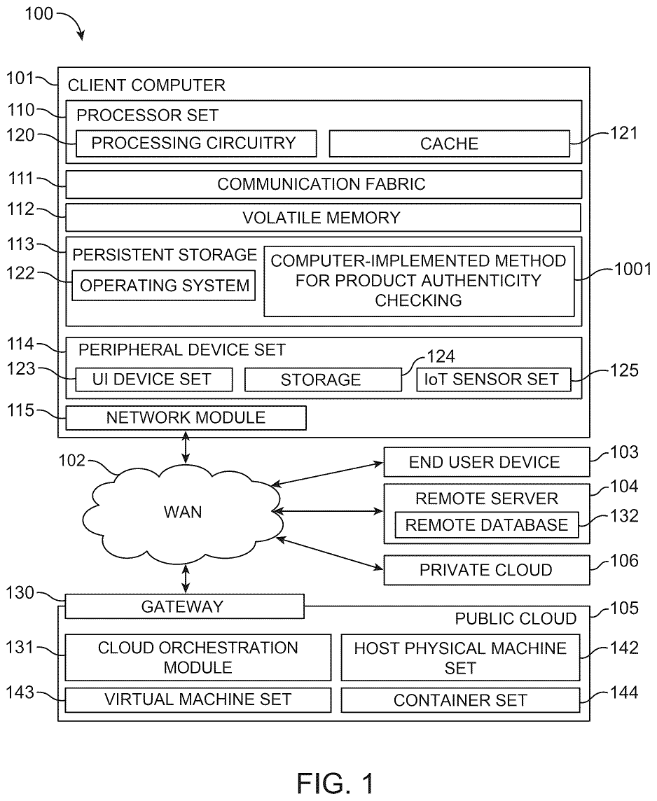

With reference to FIG. 1, a computer or computing device 100 that implements a computer-implemented method for product authenticity checking. The computer or computing device 100 of FIG. 1 contains an example of an environment for the execution of at least some of the computer code involved in performing the inventive methods, such as the block 1001 of the computer-implemented method for product authenticity checking. In addition to the computer-implemented method for product authenticity checking, the computer or computing device 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the computer-implemented method of block 1001, as identified above), peripheral device set 114 (including user interface (UI) device set 123, storage 124, and Internet of Things (IoT) sensor set 125), and network module 115. Remote server 104 includes remote database 130. Public cloud 105 includes gateway 130, cloud orchestration module 131, host physical machine set 142, virtual machine set 143, and container set 144.

The computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of the computer-implemented method, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

The processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In the computer-implemented method, at least some of the instructions for performing the inventive methods may be stored in the block 1001 of the computer-implemented method in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the block 1001 of the computer-implemented method typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 131. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Turning now to an overview of technologies that are more specifically relevant to aspects of the invention, due to multiple distribution patterns of manufactured products, it is becoming common for counterfeiters to distribute inauthentic, less expensive poor-quality products as counterfeits. While certain websites that can provide guidance as to whether a product is or is not authentic exists, such sites rely on having comprehensive data on the item in question to offer a reliable answer. Such comprehensive data may not always be readily available. With the expansion of online shopping for both new and used products as well as the use of distribution centers, the authenticity of a given product can be even more doubtful, especially where return policies allow for a lack of vigilance.

A parallel development to go along with the growing need for product authentication has been the improvement of smart-phones and mobile devices. Indeed, with modern smart-phones in particular, consumers can generate three dimensional (3D)-models in multiple formats and can obtain basic spectroscopic (e.g., Raman, IR, etc.) data to identify materials along with generating conventional photographs at very low cost.

Turning now to an overview of the aspects of the invention, one or more embodiments of the invention address the above-described shortcomings of the prior art by providing for a system and method for authentication of a product that includes an artificial intelligence (AI) model and a dynamic multi-modal product database. The product database can include a defined product class that contains information of the item as well as its brand and may contain additional product data such as material data of the product's features, tag information (e.g., country of origin) as well as 2D and 3D images of the product. The AI model may be used to define characteristic brand features and may revise product class definitions when trained with newer data on a product. The AI model may also include analogous material information dependent on a product's country of origin.

The system and method will measure and sample products from known brands and will generate a multi-modal dataset with attributes corresponding to each brand by measuring known brand products to thereby create a ‘fingerprint’ for each brand as well as a signature for materials dependent on country of origin. Subsequently, during authenticity testing of a product of an asserted brand, a likelihood of authenticity can be determined based on characteristics and measured properties of the product and comparisons thereof with known characteristics and material properties of an authentic product. These comparisons go beyond image comparisons and can look at materials data for authentication in particular, creating dynamically updated tacit knowledge of a brand's products and the features of those products. Meanwhile, if a brand changes a country of origin for a given product, materials information can be updated and used to fine-tune the authenticity determination.

The above-described aspects of the invention address the shortcomings of the prior art by providing a computer-implemented method for product authenticity checking. The computer-implemented method for product authenticity checking includes training an artificial intelligence (AI) model for product authenticity checking using characteristic data and material data of baseline products known to be authentic, generating imagery and material information of a field product of unknown authenticity using image generating components and scanning components, respectively, of a portable computing device and deriving characteristic data and material data of the field product from the imagery and the material information, respectively. The computer-implemented method further includes determining, using the AI model, a likelihood-of-authenticity score of the field product based on results of first comparisons between the characteristic data of the field product and the characteristic data of the baseline products and second comparisons between the material data of the field product and the material data of the baseline products and issuing an alert in an event the likelihood-of-authenticity score of the field product is below a first threshold.

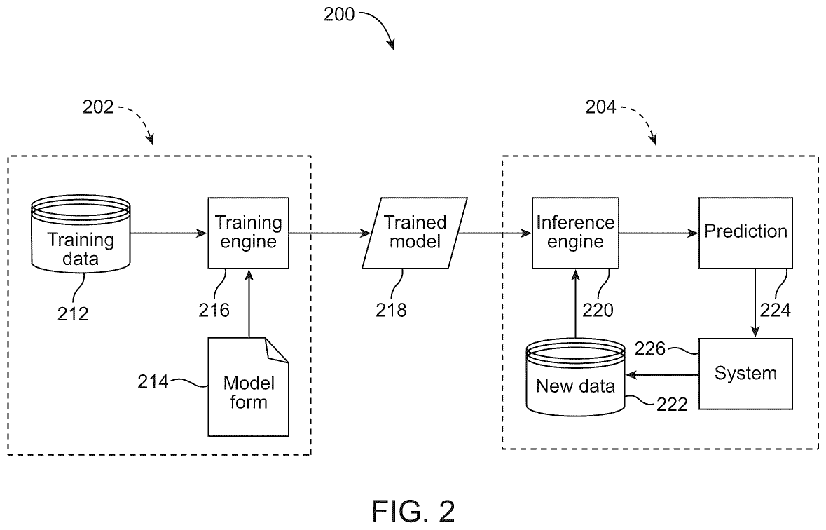

Turning now to a more detailed description of aspects of the present invention, FIG. 2 depicts a block diagram of components of a machine learning training and inference system 200 for product authenticity checking. The machine learning training and inference system 200 for product authenticity checking, in accordance with one or more embodiments of the invention, can utilize machine learning techniques to perform tasks, such as a computer-implemented method for product authenticity checking. Embodiments of the invention utilize AI, which includes a variety of so-called machine learning technologies. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used for managing information during a web conference, for example. In one or more embodiments of the invention, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments of the invention described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in AN Ns that carry electronic messages between simulated neurons are provided with numeric weights that correspond to the strength or weakness of a given connection. The weights can be adjusted and tuned based on experience, making A NNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of localizing a target object referred by a compositional expression from an image set with similar visual elements as described herein.

The machine learning training and inference system 200 for product authenticity checking performs training 202 and inference 204. During training 202, a training engine 216 trains a model (e.g., the trained model 218) to perform a task. Inference 204 is the process of implementing the trained model 218 to perform the task in the context of a larger system (e.g., a system 226).

The training 202 begins with training data 212, which can be structured or unstructured data. The training engine 216 receives the training data 212 and a model form 214. The model form 214 represents a base model that is untrained. The model form 214 can have preset weights and biases, which can be adjusted during training. It should be appreciated that the model form 214 can be selected from many different model forms depending on the task to be performed. For example, where the training 202 is to train a model to perform image classification, the model form 214 can be a model form of a CNN (convolutional neural network). The training 202 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 212 includes labeled images, including images of the object of interest with associated labels (ground truth) and other images that do not include the object of interest with associated labels. In this example, the training engine 216 takes as input a training image from the training data 212, makes a prediction for classifying the image, and compares the prediction to the known label. The training engine 216 then adjusts weights and/or biases of the model based on results of the comparison, such as by using backpropagation. The training 202 can be performed multiple times (referred to as “epochs”) until a suitable model is trained (e.g., the trained model 218).

Once trained, the trained model 218 can be used to perform inference 204 to perform a task. The inference engine 220 applies the trained model 218 to new data 222 (e.g., real-world, non-training data). For example, if the trained model 218 is trained to classify images of a particular object, such as a chair, the new data 222 can be an image of a chair that was not part of the training data 212. In this way, the new data 222 represents data to which the model 218 has not been exposed. The inference engine 220 makes a prediction 224 (e.g., a classification of an object in an image of the new data 222) and passes the prediction 224 to the system 226. The system 226 can, based on the prediction 224, taken an action, perform an operation, perform an analysis, and/or the like, including combinations and/or multiples thereof. In some embodiments of the invention, the system 226 can add to and/or modify the new data 222 based on the prediction 224.

In accordance with one or more embodiments of the invention, the predictions 224 generated by the inference engine 220 are periodically monitored and verified to ensure that the inference engine 220 is operating as expected. Based on the verification, additional training 202 can occur using the trained model 218 as the starting point. The additional training 202 can include all or a subset of the original training data 212 and/or new training data 212. In accordance with one or more embodiments of the invention, the training 202 includes updating the trained model 218 to account for changes in expected input data.

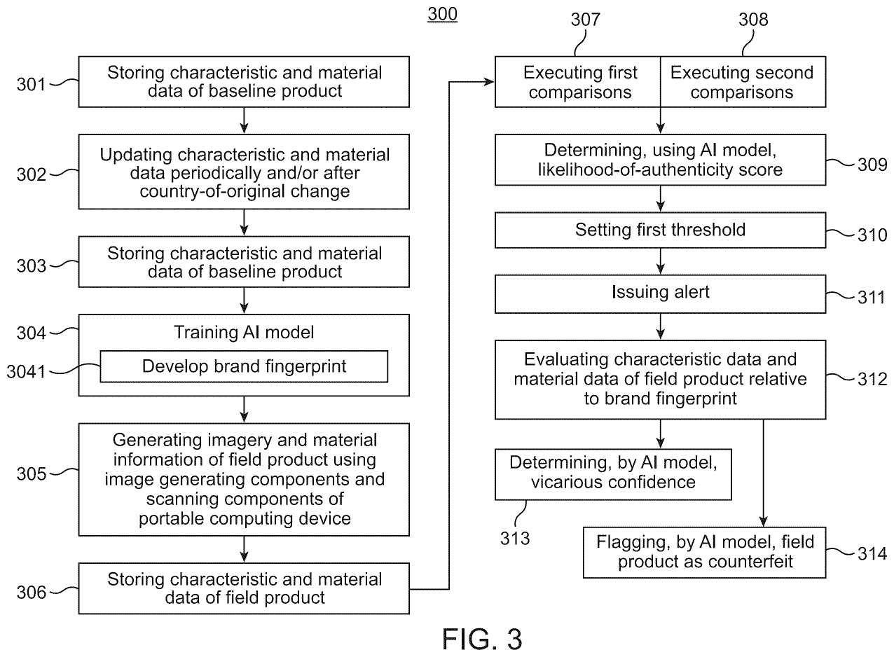

With reference to FIG. 3, a computer-implemented method 300 for product authenticity checking is provided. The computer-implemented method 300 for product authenticity checking includes storing characteristic data and material data of baseline products that are known to be authentic in a multi-modal database of one or more products of one or more brands (block 301) and updating the characteristic data and the material data of the baseline products periodically and/or in an event of a change in a country-of-origin of any one or more of the baseline products (block 302). The computer-implemented method 300 then includes generating an AI model for product authenticity checking (block 303) and training the AI model for product authenticity checking using characteristic data and material data of the baseline products (block 304). The training of the AI model of block 304 can be iterative, especially in the case where the updating of block 302 is periodic and/or has occurred in the event of the change in the country-of-origin of the any one or more of the baseline products.

The computer-implemented method 300 also includes generating imagery and material information of a field product of unknown authenticity using image generating components and scanning components, respectively, of a portable computing device (block 305) and deriving characteristic data and material data of the field product from the imagery and the material information, respectively (block 306). In accordance with one or more embodiments of the present invention, the portable computing device can include or be provided as at least one of a smartphone, a tablet, a hand-held computing device and a robotic computing device, the image generating components can include or be provided as a camera of the portable computing device and the scanning components can include or be provided as at least one of sensors embedded in the portable computing device and sensors attached to the portable computing device. The camera can be configured to generate 2D and 3D images of the field product and a tag of the field product. The at least one of the sensors embedded in the portable computing device and the sensors attached to the portable computing device can be configured to generate at least a spectroscopic signature of the field product. The scanning components can include or be provided as at least one or more of ultraviolet-visible (UV-VIS) scanners, Fourier transform infrared spectroscopy (FTIR) scanners and Raman scanners.

The computer-implemented method 300 further includes executing first comparisons between the characteristic data of the field product and the characteristic data of the baseline products (block 307) and executing second comparisons between the material data of the field product and the material data of the baseline products (block 308) and determining, using the AI model, a likelihood-of-authenticity score of the field product based on results of the first comparisons and based on results of the second comparisons (block 309). In addition, the computer-implemented method 300 includes setting a first threshold based at least in part on a tolerance level of a mission critical product (block 310) and issuing an alert as to the likelihood-of-authenticity score of the field product in relation to a first threshold (block 311). In block 311, the alert can be a positive alert that is indicative of the field product being likely authentic when the likelihood-of-authenticity score of the field product exceeds the first threshold and the alert can be a negative alert that is indicative of the field product being unlikely to be authentic when the likelihood-of-authenticity score of the field product is below the first threshold. Additionally and/or alternatively, in an event the likelihood-of-authenticity score of the field product is below the first threshold, the computer-implemented method 300 can further include evaluating the characteristic data and the material data of the field product relative to a brand fingerprint (block 312), determining, by the AI model, a vicarious confidence in an authenticity of the field product based on results of the evaluating of block 312 indicating a likely match between the characteristic data and the material data of the field product relative to the brand fingerprint (block 313) and flagging, by the AI model, the field product as counterfeit based on the results of the evaluating indicating an unlikely match between the characteristic data and the material data of the field product relative to the brand fingerprint (block 314).

As used herein, a mission critical product can be a product that is used in certain industries, such as the aerospace industry, in which tolerances for the mission critical product are relatively very low and there is a significant impetus to avoid the use of and/or to weed out counterfeit products.

In accordance with one or more embodiments of the present invention, the training of the AI model of block 304 can include developing brand fingerprints for each of the one or more brands (block 3041) and, in these or other cases, the likelihood-of-authenticity score of the field product which is determined in block 309 can be a function of the results of the first comparisons and the second comparisons and thus is indicative of a degree to which the field product matches a brand fingerprint of the one or more brands.

In accordance with one or more embodiments of the present invention, the computer-implemented method 300 can also include updating the characteristic data and the material data of the baseline products known to be authentic using the characteristic data and the material data of the field product in an event the likelihood-of-authenticity score of the field product is above a second threshold (block 312). In these or other cases, the second threshold can be defined such that the likelihood-of-authenticity score of the field product is high enough to suggest a high confidence in the authenticity of the field product. The second threshold would thus be higher than the first threshold and, in many cases, significantly higher than the first threshold.

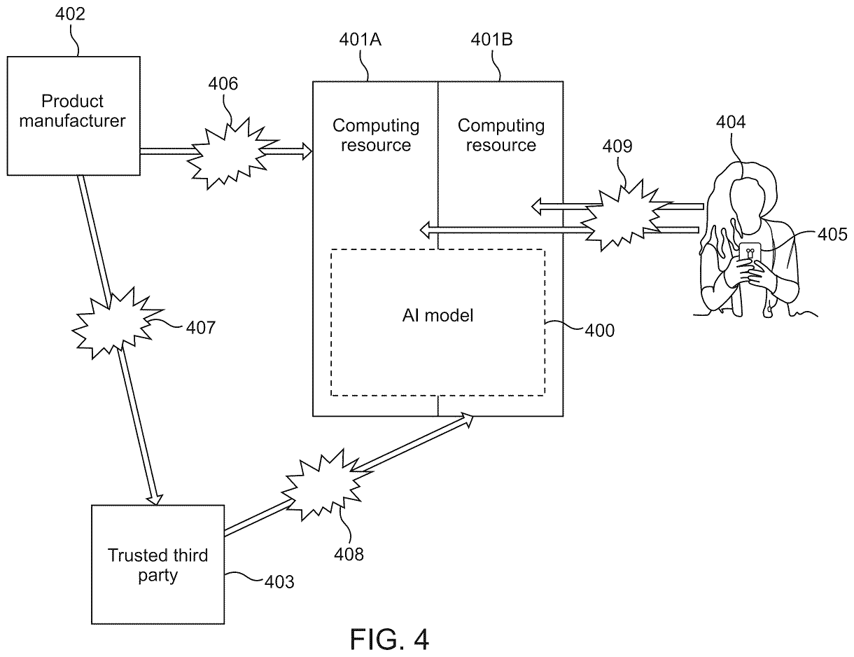

With continued reference to FIG. 3 and with additional reference to FIG. 4, the AI model 400 can be stored on a computing resource 401A, which is owned and operated by at least one or more of a product manufacturer 402, and/or on a computing resource 401B, which is owned and operated by a trusted third party 403, where the computing resource 401A, 401B is accessible by an authorized user 404 of the portable computing device 405. In the case of the AI model 400 being stored on the computing resource 401A that is owned and operated by the product manufacturer 402, the product manufacturer 402 possesses the physical characteristics and material characteristics of their products as well as country-of-origin information and supply chain information of their products and therefore can upload all of the associated data to the AI model 400 for development and training thereof by way of a secure local network 406. In the case of the AI model 400 being stored on the computing resource 401B that is owned and operated by the trusted third party 403, the product manufacturer 402 possesses the physical characteristics and material characteristics of their products as well as country-of-origin information and supply chain information of their products and forwards all of the associated data to the trusted third party 403 via a secure network 407 and the trusted third party 403 then uploads all of the associated data to the AI model 400 via a secure local network 408 for development and training thereof. In either case, the authorized user 404 can access the computing resource 401A, 401B via a secure network 409 and through, for example, an application stored on the portable computing device 405 when the authorized user 404 encounters a product that he/she wants to check for authenticity.

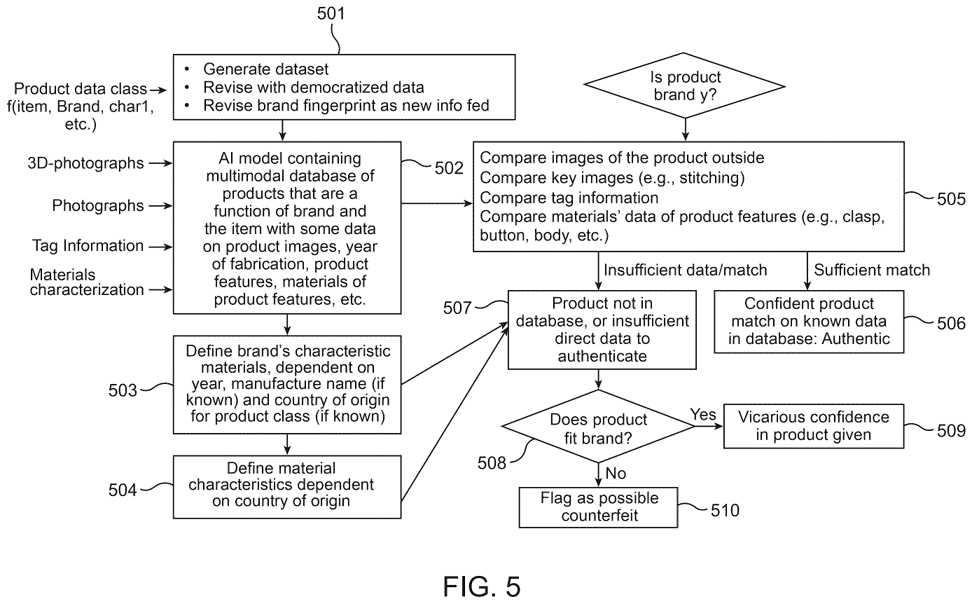

With continued reference to FIGS. 3 and 4 and with additional reference to FIG. 5, an operational flow of the computer-implemented method 300 of FIG. 3 is provided. As shown, the left-side blocks in FIG. 5 generally but not precisely correspond to blocks 301-304 of FIG. 3 and the right-side blocks in FIG. 5 generally but not precisely correspond to blocks 305-311 of FIG. 3.

A brand fingerprint is generated (block 501) with a generated dataset and is revised with democratized data and as new information is fed into the system. This generally corresponds to the storing and the updating of blocks 301 and 302 of FIG. 3. The brand fingerprint is then input into an AI model along with 2D and 3D photographs, tag information and materials characterizations (block 502). In block 502, the AI model includes a multi-modal database of products with data about each product. The data can include product imagery and product information, such as its year of fabrication, its features and materials of the product and materials of each of the features. This generally corresponds to the generating of the AI model of block 303 of FIG. 3. From the AI model, characteristic physical dimensions by year, characteristic material information by year of each product along with additional information (i.e., manufacturer name and country-of-original) of each brand fingerprint are defined (block 503) and, in some cases, material characteristics of each product of each brand are defined in terms of country-of-original information (block 504). This generally corresponds to the training of the AI model of block 304 of FIG. 3.

As shown in FIG. 5, the right-side blocks of FIG. 5 are directed towards determining if a product in the field is authentic. In block 505, images of a product, including images of key portions of the product, are taken and analyzed relative to images of an authentic product and tag and material information are compiled and analyzed relative to tag and material information of an authentic product. This generally corresponds to blocks 305-309 of FIG. 3. In block 506, a positive determination of authenticity is made if the product can be confidently regarded as authentic. This generally corresponds to blocks 310 and 311 of FIG. 3.

In block 507, it may be determined that the product is not found in the database or that there may be insufficient direct data to authenticate. In these or other cases, a determination is made as to whether the product fits a particular brand in block 508. If so, vicarious confidence in the product is offered in block 509 and, if not, the product can be flagged as counterfeit in block 510. This generally corresponds to blocks 312-314 of FIG. 3.

In an exemplary use case, an aircraft component may be offered for sale for use in the aerospace industry where there is little to no tolerance for counterfeit products. A potential customer would therefore need to check and verify the authenticity of the aircraft component before completing purchase. To do this, the potential customer uses a smartphone to take multiple 2D and 3D images of the aircraft component. These 2D and 3D pictures establish sizing and dimensions of the aircraft component as well as identify particular features (i.e., a welding or stitching topology) and establish sizing and dimensions of those particular features. In addition, the potential customer attaches a sensor to the smartphone and uses the sensor to spectroscopically analyze the aircraft component whereby materials thereof can be determined. Prior to these events, an AI model is generated, updated and trained on characteristics of an authentic aircraft component. The AI model is therefore knowledgeable about the sizing and dimensions of the authentic aircraft component, the sizing and dimensions of the particular features of the authentic aircraft component and the materials of the authentic aircraft component. The customer uses the smartphone to access the AI model via the application on the smartphone and uploads all of the characteristic data and the material data of the aircraft component and requests that the AI model provide an indication of authenticity. At this point, the AI model compares the characteristic data of the aircraft component with the characteristic data of the authentic aircraft component and compares the material data of the aircraft component with the material data of the authentic aircraft component and outputs the likelihood-of-authenticity score of the aircraft component. This likelihood-of-authenticity score of the aircraft component is compared to the first threshold, which is set relatively very high in accordance with the mission criticality of the aircraft component, and a positive/negative alert is issued based on the likelihood-of-authenticity score of the aircraft component being above or below the relatively very high first threshold.

In an extension of the exemplary use case, the AI model may be updated with information suggesting that the authentic aircraft component is manufactured with first, readily available materials in a first country for a first set of years and with second, readily available materials in a second country for a second set of years. In such cases, the tag information of the aircraft component is imaged and analyzed to ascertain its fabrication year and the comparison of the material data of the aircraft component is analyzed for that fabrication year (i.e., high/low likelihood-of-authentication score would indicate that the materials of the aircraft component are consistent/inconsistent with the fabrication year determined from the tag information).

In an alternative exemplary use case, the product being questioned by the customer is not a mission critical product but rather a consumer good, such as a handbag with a certain luxury brand name. In this case, the first threshold may be reduced as compared to the mission critical instance but otherwise the analysis would be generally similar as laid out above. The potential customer uses the smartphone to take multiple 2D and 3D images of the handbag in a store or nearby a street vendor. These 2D and 3D pictures establish sizing and dimensions of the handbag as well as identify particular features (i.e., a clasp, stitching patterns, leather grain, etc.) and establish sizing and dimensions of those particular features. In addition, the potential customer could use a sensor installed in the smartphone to spectroscopically analyze the handbag to determine its material composition. Prior to these events, an AI model is generated, updated and trained on characteristics of an authentic handbag for the asserted luxury brand name. The AI model is therefore knowledgeable about the sizing and dimensions of the authentic handbag, the sizing and dimensions of the particular features of the authentic handbag and the materials of the authentic handbag (i.e., the AI model would know that the authentic handbag is hand-stitched with acceptable human errors and that a counterfeit handbag would be identifiable by its uniform machine stitching). The customer then uses the smartphone to access the AI model via the application on the smartphone and uploads all of the characteristic data and the material data of the handbag and requests that the AI model provide an indication of authenticity. At this point, the AI model compares the characteristic data of the handbag with the characteristic data of the authentic handbag and compares the material data of the handbag with the material data of the authentic handbag and outputs the likelihood-of-authenticity score of the handbag as a function of the handbag being consistent/inconsistent with those of the luxury brand name. This likelihood-of-authenticity score of the handbag is compared to the first threshold, which is reduced as compared with the first threshold of the mission critical aircraft component, and a positive/negative alert is issued based on the likelihood-of-authenticity score of the handbag being above or below the first threshold.

In an extension of the alternative exemplary use case, the customer is an operator of an online marketplace and needs to verify the authenticity of the handbag prior to it being sold to a buyer so as to maintain a reputation of the online marketplace. In such cases, the sizing and dimensions of the handbag, the sizing and dimensions of the particular features of the handbag and the material composition of the handbag are determined by a robot that is owned and operated by the online marketplace.

In another extension of the alternative exemplary use case, the AI model may not have any data on handbags at all. In such cases, the AI model could develop a brand fingerprint of the luxury brand name with characteristic features such as insignia made of specific metals. While the AI model might not be able to generate the likelihood-of-authenticity score due to the lack of data, the AI model could still determine a vicarious confidence in the authenticity of the handbag from the sizing and dimensions of the particular features of the handbag and the material composition of the handbag being consistent with the characteristic features of the luxury brand name.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

The phrase “selective to,” such as, for example, “a first element selective to a second element,” means that the first element can be etched and the second element can act as an etch stop.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method for product authenticity checking, comprising:
training an artificial intelligence (AI) model for product authenticity checking using characteristic data and material data of baseline products known to be authentic;
generating imagery and material information of a field product of unknown authenticity using image generating components and scanning components, respectively, of a portable computing device,
wherein the image generating components comprise a camera of the portable computing device, the camera being configured to generate two-dimensional (2D) and three-dimensional (3D) images of the field product and a tag thereof, the scanning components comprise sensors embedded in or attached to the portable computing device and configured to generate at least a spectroscopic signature of the field product and the portable computing device comprises at least one of a smartphone, a tablet, a hand-held computing device and a robotic computing device;
deriving characteristic data and material data of the field product from the 2D and 3D images and deriving material data of the field product from the spectroscopic signature;
determining, using the AI model, a likelihood-of-authenticity score of the field product based on results of first comparisons between the characteristic data of the field product derived from the 2D and 3D images and the characteristic data of the baseline products and second comparisons between the material data of the field product derived from the spectroscopic signature and the material data of the baseline products; and
issuing an alert as to the likelihood-of-authenticity score of the field product in relation to a first threshold.

2. The computer-implemented method according to claim 1, wherein:
the characteristic data and the material data of the baseline products are stored in a multi-modal database of one or more products of one or more brands,
the training comprises developing brand fingerprints for each of the one or more brands, and
the likelihood-of-authenticity score of the field product is a function of the results of the first comparisons and the second comparisons indicating a degree to which the field product matches a brand fingerprint.

3. The computer-implemented method according to claim 1, further comprising at least one of:
updating the characteristic data and the material data of the baseline products known to be authentic using the characteristic data and the material data of the field product in an event the likelihood-of-authenticity score of the field product is above a second threshold; and
updating the characteristic data and the material data of the baseline products known to be authentic in an event of a change in a country-of-origin of a baseline product.

4. (canceled)

5. The computer-implemented method according to claim 1, wherein the scanning components comprise Raman scanners.

6. The computer-implemented method according to claim 1, further comprising setting the first threshold based on a tolerance level of a mission critical product.

7. The computer-implemented method according to claim 1, wherein, in an event the likelihood-of-authenticity score of the field product is below the first threshold, the computer-implemented method further comprises:
evaluating the characteristic data and the material data of the field product relative to a brand fingerprint;
determining, by the AI model, a vicarious confidence in an authenticity of the field product based on results of the evaluating indicating a likely match between the characteristic data and the material data of the field product relative to the brand fingerprint; and
flagging, by the AI model, the field product as counterfeit based on the results of the evaluating indicating an unlikely match between the characteristic data and the material data of the field product relative to the brand fingerprint.

8. The computer-implemented method according to claim 1, wherein the AI model is stored on a computing resource, which is owned and operated by a trusted third part and which is accessible by an authorized user of the portable computing device via a network.

9. A computer program product for product authenticity checking, the computer program product comprising one or more non-transitory computer readable storage media having computer readable program code collectively stored on the one or more computer readable storage media, the computer readable program code being executed by a processor of a computer system to cause the computer system to perform a method comprising:
training an artificial intelligence (AI) model for product authenticity checking using characteristic data and material data of baseline products known to be authentic;
generating imagery and material information of a field product of unknown authenticity using image generating components and scanning components, respectively, of a portable computing device,
wherein the image generating components comprise a camera of the portable computing device, the camera being configured to generate two-dimensional (2D) and three-dimensional (3D) images of the field product and a tag thereof, the scanning components comprise sensors embedded in or attached to the portable computing device and configured to generate at least a spectroscopic signature of the field product and the portable computing device comprises at least one of a smartphone, a tablet, a hand-held computing device and a robotic computing device;
deriving characteristic data of the field product from the 2D and 3D images and deriving material data of the field product from the spectroscopic signature; material data of the field product from the imagery and the material information, respectively;
determining, using the AI model, a likelihood-of-authenticity score of the field product based on results of first comparisons between the characteristic data of the field product derived from the 2D and 3D images and the characteristic data of the baseline products and second comparisons between the material data of the field product derived from the spectroscopic signature and the material data of the baseline products; and
issuing an alert as to the likelihood-of-authenticity score of the field product in relation to a first threshold.

10. The computer program product according to claim 9, wherein:
the characteristic data and the material data of the baseline products are stored in a multi-modal database of one or more products of one or more brands,
the training comprises developing brand fingerprints for each of the one or more brands, and
the likelihood-of-authenticity score of the field product is a function of the results of the first comparisons and the second comparisons indicating a degree to which the field product matches a brand fingerprint.

11. The computer program product according to claim 9, wherein the method further comprises at least one of:
updating the characteristic data and the material data of the baseline products known to be authentic using the characteristic data and the material data of the field product in an event the likelihood-of-authenticity score of the field product is above a second threshold; and
updating the characteristic data and the material data of the baseline products known to be authentic in an event of a change in a country-of-origin of a baseline product.

12. (canceled)

13. The computer program product according to claim 9, wherein the method further comprises setting the first threshold based on a tolerance level of a mission critical product.

14. The computer program product according to claim 9, wherein the AI model is stored on a computing resource, which is owned and operated by a trusted third part and which is accessible by an authorized user of the portable computing device via a network.

15. A computing system comprising:
a processor;
a memory coupled to the processor; and
one or more computer readable storage media coupled to the processor, the one or more computer readable storage media collectively containing instructions that are executed by the processor via the memory to implement a method for product authenticity checking comprising:
training an artificial intelligence (AI) model for product authenticity checking using characteristic data and material data of baseline products known to be authentic;
generating imagery and material information of a field product of unknown authenticity using image generating components and scanning components, respectively, of a portable computing device,
wherein the image generating components comprise a camera of the portable computing device, the camera being configured to generate two-dimensional (2D) and three-dimensional (3D) images of the field product and a tag thereof, the scanning components comprise sensors embedded in or attached to the portable computing device and configured to generate at least a spectroscopic signature of the field product and the portable computing device comprises at least one of a smartphone, a tablet, a hand-held computing device and a robotic computing device;
deriving characteristic data of the field product from the 2D and 3D images and deriving material data of the field product from the spectroscopic signature;
determining, using the AI model, a likelihood-of-authenticity score of the field product based on results of first comparisons between the characteristic data of the field product derived from the 2D and 3D images and the characteristic data of the baseline products and second comparisons between the material data of the field product derived from the spectroscopic signature and the material data of the baseline products; and
issuing an alert as to the likelihood-of-authenticity score of the field product in relation to a first threshold.

16. The computing system according to claim 15, wherein:
the characteristic data and the material data of the baseline products are stored in a multi-modal database of one or more products of one or more brands,
the training comprises developing brand fingerprints for each of the one or more brands, and
the likelihood-of-authenticity score of the field product is a function of the results of the first comparisons and the second comparisons indicating a degree to which the field product matches a brand fingerprint.

17. The computing system according to claim 15, wherein the method for product authenticity checking further comprises at least one of:
updating the characteristic data and the material data of the baseline products known to be authentic using the characteristic data and the material data of the field product in an event the likelihood-of-authenticity score of the field product is above a second threshold; and
updating the characteristic data and the material data of the baseline products known to be authentic in an event of a change in a country-of-origin of a baseline product.

18. (canceled)

19. The computing system according to claim 15, wherein the method for product authenticity checking further comprises setting the first threshold based on a tolerance level of a mission critical product.

20. The computing system according to claim 15, wherein the AI model is stored on a computing resource, which is owned and operated by a trusted third part and which is accessible by an authorized user of the portable computing device via a network.
